(19) United States
(12) Patent Application Publication
(10) Pub. No.: US 2015/0217720 A1
(43) Pub. Date: Aug. 6, 2015

(54) SEAT BELT ASSEMBLY

(71) Applicant: Toyota Motor Engineering & Manufacturing North America, Inc., Erlanger, KY (US)

(72) Inventors: Palaniappan Palaniappan, Ann Arbor, MI (US); Jason J. Hallman, Saline, MI (US)

(73) Assignee: Toyota Motor Engineering & Manufacturing North America, Inc., Erlanger, KY (US)

(21) Appl. No.: 14/172,666

(22) Filed: Feb. 4, 2014

(51) Int. Cl. B60R 22/06; B60R 22/22

(52) U.S. Cl. CPC B60R 22/06; B60R 22/22

(57) ABSTRACT

A seat belt assembly for use with a seat is provided. The seat belt assembly is configured to drag the seat belt across the lap of the user so as to position the seat belt over the pelvis of the user. The seat belt assembly includes a seat belt anchor movable between a locked position and a receiving position. The locked position is generally adjacent a back edge of the seat cushion and proximate the seat back. The receiving position is forward of the locked position. After the belt buckle is locked into the seat belt anchor, the seat belt anchor is moved back to the locked position, dragging the belt across the user's lap and onto the user's pelvis area.

### FIELD OF THE INVENTION

The invention relates to a seat belt assembly configured to facilitate the proper placement of the seat belt. In particular, the seat belt assembly is configured to move the attachment point between the belt buckle and the seat belt anchor forward of the waistline of the user so as to facilitate the placement of the belt generally above the pelvis of the user.

### BACKGROUND OF THE INVENTION

Seat belt assemblies are used to restrain an occupant to a seat. The seat belt assembly is most effective when a portion of the seat belt is fitted over the pelvis of a user. However, in instances where the user has a large abdomen or poor posture, the user may place the seat belt over his or her abdominal region, as shown in FIGS. 2 and 4 respectively. Current seat belt anchors are fixedly attached to a bottom edge of the seat cushion and also a back portion of the seat back. Thus, as the user pulls the belt and places the belt buckle into the seat anchor, the belt is positioned over the abdominal region. Accordingly, it is desirable to have a seat belt assembly which facilitates the placement of the belt over the user's pelvis as opposed to over the user's stomach.

### SUMMARY OF THE INVENTION

According to one aspect of the invention, a seat belt assembly for use with a seat having a seat cushion and a seat back is provided. The seat belt assembly is configured to facilitate the proper placement of the seat belt. The seat belt assembly includes a belt buckle which is slidably mounted to the seat belt. A seat belt anchor is movable between a locked position and a receiving position. The locked position is generally adjacent a back edge of the seat cushion and is proximate the seat back. The receiving position is forward of the locked position. In operation, the seat belt anchor receives the belt buckle in the receiving position and the seat belt anchor is moved back to the locked position sliding the seat belt over the lap of the user and resting the seat belt over the user's pelvis.

A seat assembly is also provided. The seat assembly includes a seat cushion, a seat back, and a seat belt assembly. The seat belt assembly includes a belt buckle slidably mounted to a seat belt. The seat assembly is configured to help position the seat belt over the pelvis of the user. The seat assembly further includes a seat belt anchor. The seat belt anchor is movable between a locked position and a receiving position. The locked position is generally adjacent a back edge of the seat cushion and a bottom edge of the seat back. The receiving position is forward of the locked position. The seat belt anchor receives the seat belt in the receiving position. When the seat belt is engaged with the seat belt anchor, the seat belt anchor and the belt buckle are moved back to the locked position sliding the seat belt over the lap of the user and placing the seat belt over the pelvis of the user.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of the first preferred embodiment of a seat belt assembly;

FIG. 2 is a perspective view showing the seat belt over the abdomen of a user having a relatively large body mass index;

FIG. 3 is perspective view of the seat belt assembly showing the movement of the seat belt anchor between the forward and locked position;

FIG. 4 is a view showing the misplaced seat belt used by a user having poor posture;

FIG. 5 is perspective view of the seat belt assembly showing a load sensor used to detect the position of the pelvis with respect to the seat cushion;

FIG. 6 is a top-down view showing the seat belt assembly in both the receiving position and the locked position; and

FIG. 7 is a perspective view of a seat belt assembly showing the rail mounted to the floor of a cabin space.

### DETAILED DESCRIPTION OF THE INVENTION

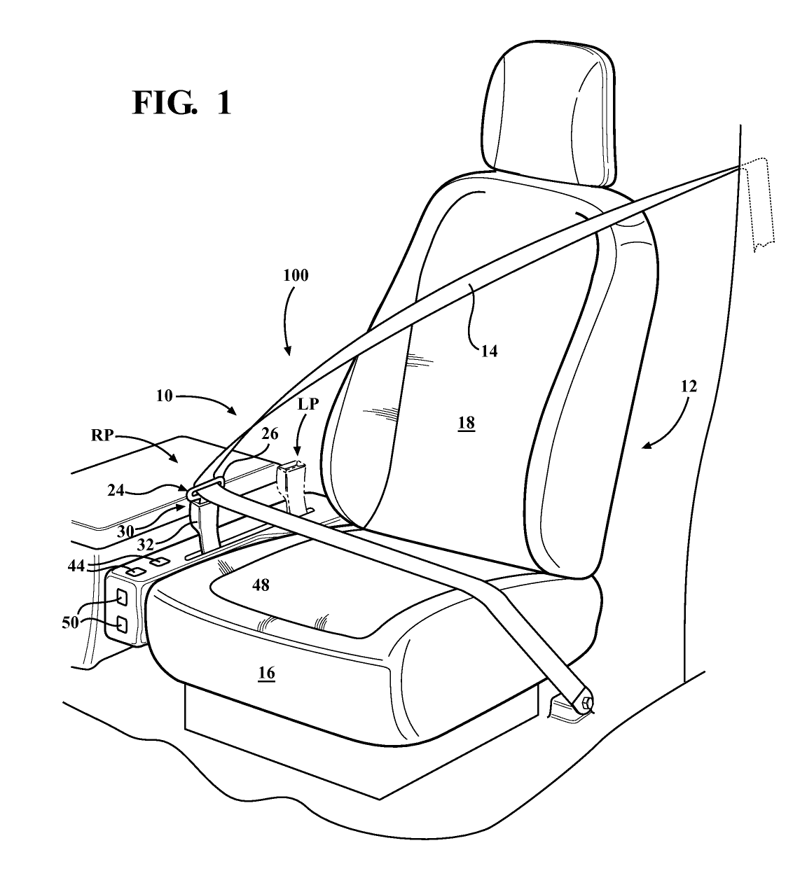

With reference now to FIGS. 1, 3 and 7, a seat belt assembly 10 for use with a seat 12 is provided. The seat belt assembly 10 is configured to drag the seat belt 14 across the lap of the user so as to position the seat belt 14 over the pelvis of the user. The seat 12 includes a seat cushion 16 and a seat back 18. The seat 12 may be used in the cabin space 20 of a vehicle 22, such as an automobile. The seat cushion 16 may be adjustable with respect to the length of cabin space 20. The seat back 18 may be inclined.

For illustrative purposes, the seat belt assembly 10 is shown used in the cabin space 20 of an automobile. However, it should be appreciated that the seat belt 14 may be used in the cabin space 20 of other vehicles 22, such as a train, bus, or airplane. Further, the seat belt assembly 10 is shown configured to fit over both the shoulder and lap of the user. However, it should be appreciated that the seat belt assembly 10 may be configured to only come across the lap of the user.

The seat belt assembly 10 includes a belt buckle 24. The belt buckle 24 is slidably mounted to a seat belt 14. The belt buckle 24 includes a base 26 having a slit through which the seat belt 14 is passed, and a keyed member 28. The keyed member 28 extends outwardly from the base 26. The keyed member 28 includes an eye (not shown).

The seat belt assembly 10 includes a seat belt anchor 30. The seat belt anchor 30 includes a head 32 having a slot 34 and an actuator 36 configured to release the belt buckle 24 from the slot 34. The eye of the keyed member 28 of the base 26 is dimensioned to fit within the head 32 of the seat belt anchor 30. The head 32 of the seat belt anchor 30 includes a clasping mechanism (not shown) configured to engage the eye of the keyed member 28 so as to lock the belt buckle 24 to the seat belt anchor 30. The belt buckle 24 may be released from head 32 of the seat belt anchor 30 by actuating the actuator 36.

The seat belt assembly 10 may further include a rewinding device disposed on one end of the seat belt 14. As shown in FIGS. 3, 5 and 7, the rewinding device is disposed within a housing adjacent the side pillar of the vehicle 22. The rewinding device is configured to reel in any slack in the seat belt 14 after the belt buckle 24 is engaged with the seat belt anchor 30. Any rewinding device currently known or used in the art may be adaptable for use herein. The other end of the seat belt 14 may be fixedly mounted to the floor of the cabin space 20, as shown in FIG. 1.

As shown in FIG. 1, the seat belt anchor 30 is movable between a locked position, indicated by “LP,” and a receiving position, indicated by “RP”. The receiving position is forward of the locked position when used in the context of a forward facing seat with respect to the orientation of the vehicle 22. Accordingly, in the context of a rear facing seat, the receiving position is rearward of the locked position with respect to the orientation of the vehicle 22.

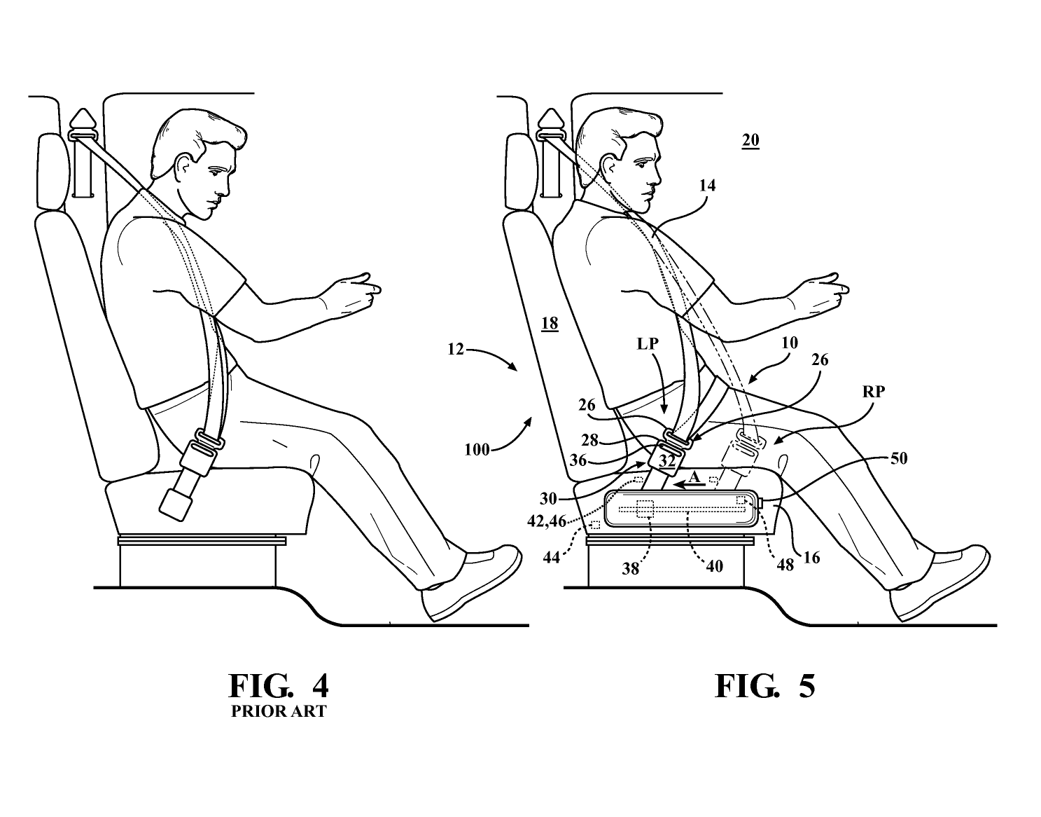

The seat belt anchor 30 is generally movable along an axis, labeled “A” and indicated by the arrow in FIGS. 3, 5 and 7. Axis “A” is generally horizontal and parallel to the floor of the cabin 20 in which the seat 12 is housed. With reference again to FIGS. 3 and 5, the seat belt anchor 30 is adjacent the pelvis of the user when in the locked position.

The seat belt anchor 30 may be manually moved between the locked position and the receiving position. Alternatively, the seat belt 14 may be automatically moved between the locked position and the receiving position. In such an embodiment, the seat belt assembly 10 may further include a drive 38. The drive 38 may be a motorized unit configured to move the seat belt anchor 30 between the locked position and the receiving position.

The seat belt assembly 10 may further include a rail 40. The rail 40 extends along the axis “A” which is generally horizontal. The rail 40 may be formed of a rigid and durable material such as steel. The seat belt anchor 30 is mechanically attached to the rail 40 and movable along the rail 40 between the locked position and the receiving position. It should be appreciated in some configurations that the rail 40 is mounted directly to a side of the seat cushion 16, as shown in FIGS. 3 and 5. Such an embodiment may be preferable for seats having a built in seat belt assembly 10. Alternatively, the rail 40 may be mounted to the floor of the vehicle 22 as shown in FIG. 7. Such an embodiment may be used for captain's chairs which may be found in passenger vans.

The rail 40 is shown in FIGS. 3, 5, and 7 by a broken line extending axially and generally parallel to the floor. In an example of an automated system, the rail 40 may have a threaded surface (not shown) and an end of the seat belt anchor 30 is mechanically mounted to the rail 40. The end of the seat belt anchor 30 may include a screw (not shown) mounted to the threaded rail 40. The drive 38 is configured to turn the screw so as to automatically move the seat anchor between the locked and receiving positions.

With reference now to FIG. 3, an example of a manual system is provided. The seat belt assembly 10 may include a pivotable claw 41 and the rail 40 may include a tooth 40a at the locked position and another tooth at the receiving position. The pivotable claw 41 is biased against one of the tooth 40a so as to retain the seat belt anchor 30 in a respective locked or receiving position. The user may simply actuate the pivotable claw 41, freeing the pivotable claw 41 from the tooth 40a, and slide the seat belt anchor 30 along the rail 40 between the locked and receiving position.

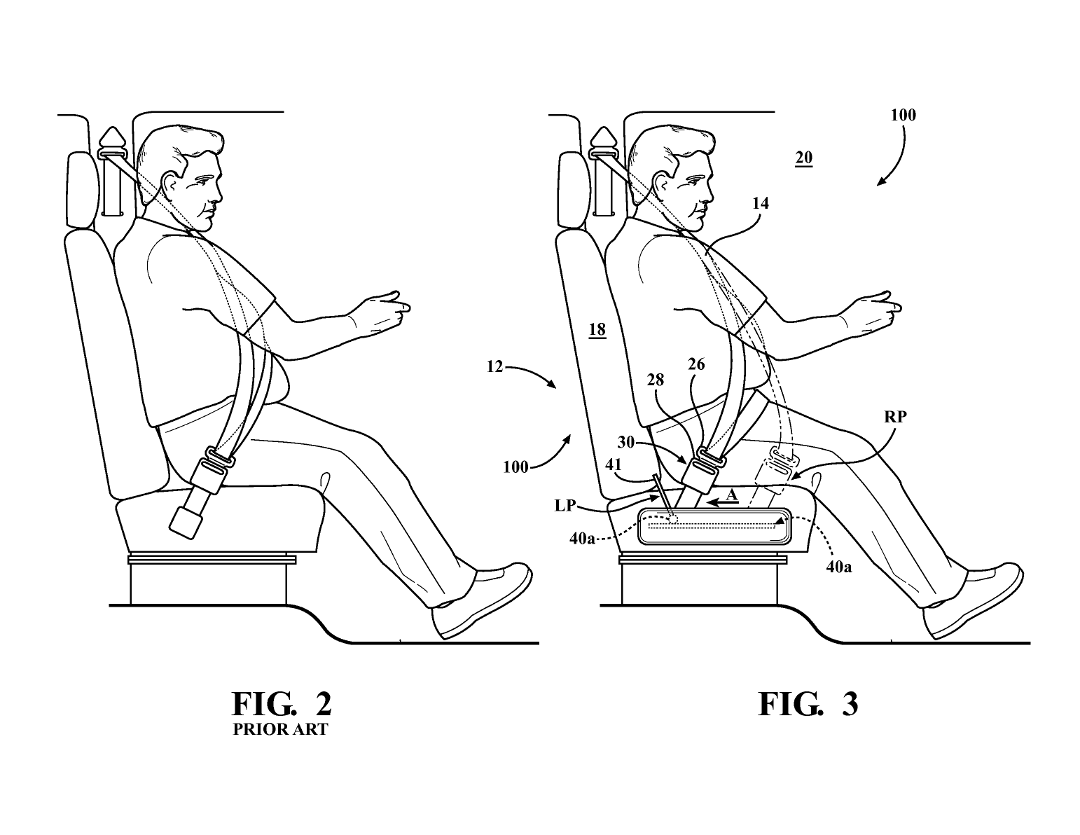

As shown in FIGS. 2 and 3, the seat 12 is forward facing and the receiving position is forward of the locked position. Thus, as the user grabs the belt buckle 24 to insert the belt buckle 24 into the seat belt anchor 30, a portion of the seat belt 14 is positioned forward of the abdominal region of the user and onto a portion of the user's lap that is adjacent the user's knee. When the user inserts the belt buckle 24 into head 32 of the seat belt anchor 30, a portion of the seat belt 14 rests against the user's lap. When the belt buckle 24 is locked into the seat belt anchor 30, the seat belt anchor 30 moves, either manually or automatically, from the receiving position back to the locking position, dragging the seat belt 14 against the lap and under the belly of the user.

With reference now to FIG. 5, the seat belt assembly 10 may also be used to ensure that users with poor posture, in particular users who slouch, also have the seat belt 14 positioned properly over the pelvis. Users who slouch tend to have their hips displaced forward of the seat 12 relative to users who do not slouch. Thus, when utilizing seat belt assemblies wherein the seat belt anchor 30 is fixed adjacent the back edge of the seat cushion 16, the seat belt 14 may be dragged over a lower portion of the user's abdominal area.

The seat belt assembly 10 may further include a position sensor 42, and a processor 44. The position sensor 42 is configured to detect the position of the hips of a user with respect to the bottom of the seat back 18, or the user side surface of the seat cushion 16. The position sensor 42 may be a load sensor 46 disposed within the seat cushion 16. Thus, by experiencing a load and the location of the load with respect to the seat cushion 16, the processor 44 may be programmed to calculate the space between the back side of the user and the front side of the seat cushion 16. The calculated space may be processed so as to adjust the position of the locked position. Specifically, the calculated space may be used to set the locked position of the seat belt anchor 30 to a position adjacent the hips of the user which may be different from the factory setting. Accordingly, the position sensor 42 is configured to determine the location of the hips so as to allow the seat belt anchor 30 to adjust its locked position so as to place the seat belt 14 over the pelvis of the user.

In operation, the seat belt anchor 30 is moved to the receiving position. The user sits down on the seat cushion 16 and drags the belt buckle 24 to the seat belt anchor 30, pulling the seat belt 14 across the user's body. At this point, the seat belt anchor 30 is forward of the locked position. After the belt buckle 24 is locked with the seat belt anchor 30, the seat belt anchor 30 moves to the locked position. As the seat belt anchor 30 moves to the locked position, the seat belt 14 is dragged along the lap of the user. The processor 44 receives information from the position sensor 42 so as to calculate where the user's hips are with respect to the seat 12. In instances where the user slouches, the hips may be forward of the seat cushion 16 with respect to a non-slouching user. Thus the processor 44 adjusts the position of the locked position, which is generally forward of a factory setting, so as to generally aligned the head 32 of the seat belt anchor 30 with the hips of the user.

The seat belt assembly 10 may further include a memory unit 48 and an input 50. The memory unit 48 may be an electronic medium configured to store data. For instance, the memory unit 48 may be configured to store at least one location of the receiving position and at least one location of the locked position. Thus, the input 50 is configured to interface with the memory unit 48 so as to recall any one of the receiving positions or locked positions stored in the memory unit 48. Accordingly, the memory unit 48 may be configured to store the position of the receiving position which the user has adjusted from a factory set position. The memory unit 48 may be further configured to store an adjusted locked position, wherein the adjusted locked position is the automatic adjustment of the seat belt anchor 30 by the position sensors 42 so as to account for the location of the user's hips. The stored locked and receiving positions may be associated with a particular user. Thus, if two users have profiles stored in a vehicle 22 and both users slouch, the adjusted locked position for one user may be forward of the adjusted locked position of another user.

The processor 44 may be further configured to detect a first event and a second event. The first event is a signal which indicates to the drive 38 to move the seat belt anchor 30 from the receiving position to the locked position. The second event is a signal which indicates to the drive 38 to move the seat belt anchor 30 from the locked position to the receiving position. A first event may be established when the user sits on the seat cushion 16 and the seat belt buckle 24 is coupled to the seat belt anchor 30. Thus, when the seat belt assembly 10 recognizes a first event, the drive 38 is actuated so as to move the seat belt anchor 30 from the receiving position to the locked position. The second event may be when the user disengages the belt buckle 24 from the seat belt anchor 30 and leaves the seat after a driving event. Thus, for instance, having driven, the user may park the car and turn off the ignition and disengage the seat belt 14 from the seat belt anchor 30 wherein the seat belt anchor 30 moves from the locked position to the receiving position. Thus, being in the receiving position prior to a driving event ensures that the belt buckle 24 is received by the seat belt anchor 30 forward of the abdomen of the user thus sliding a portion of the seat belt 14 along the lap of the user and positioning the belt above the pelvis so as to ensure the seat belt 14 is fitting properly.

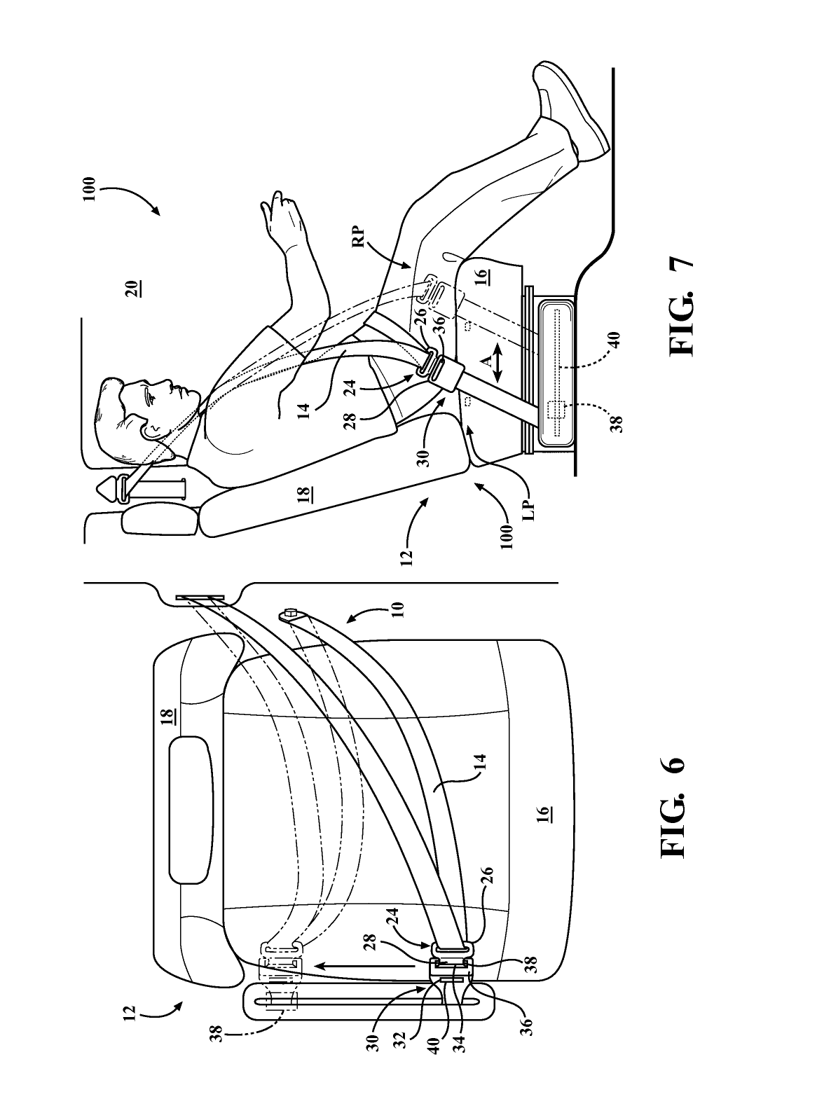

With reference again to FIGS. 2-7, a seat assembly 100 having a seat belt assembly 10 is provided. The seat belt assembly 10 includes a belt buckle 24 slidably mounted to a seat belt 14. The seat assembly 100 is configured to drag the seat belt 14 across the lap of the user so as to position the seat belt 14 over the pelvis of the user. The seat assembly 100 includes a seat 12 having a seat cushion 16 and a seat back 18. The seat 12 may be used in the cabin space 20 of a vehicle 22, such as an automobile. The seat cushion 16 may be adjustable with respect to the cabin space 20 so as to accommodate passengers of various heights. The seat back 18 may be inclined.

The seat assembly 100 further includes a seat belt anchor 30. The seat belt anchor 30 is movable between a locked position and a receiving position. The locked position is generally adjacent a back edge of the seat cushion 16 and proximate the seat back 18. The receiving position is forward of the locked position when used in the context of a forward facing seat with respect to the orientation of the vehicle 22. Accordingly, in the context of a rear facing seat, the receiving position is rearward of the locked position with respect to the orientation of the vehicle 22.

The seat belt anchor 30 is generally movable along an axis, labeled “A” and indicated by the arrow in FIGS. 3, 5 and 7. Axis “A” is generally horizontal and parallel to the floor of the cabin 20 in which the seat is housed. With reference again to FIGS. 3 and 5, the seat belt anchor 30 is adjacent the pelvis of the user when in the locked position, as indicated by “LP”.

The seat assembly 100 may further include a rail 40. The rail 40 extends along axis “A”. The rail 40 may be formed of a rigid and durable material such as steel. The seat belt anchor 30 is mechanically attached to the rail 40 and movable along the rail 40 between the locked position and the receiving position. The seat belt anchor 30 may be manually moved along the rail 40 between the locked position and the receiving position, as described above. The rail 40 may be mounted directly to a frame (not shown) of the seat cushion 16 and disposed along the side of the seat cushion 16, as shown in FIGS. 3 and 5, or mounted to the floor of the vehicle 22 as shown in FIG. 7.

The locked position is generally adjacent a back edge of the seat cushion 16 and proximate the seat back 18. However, the seat assembly 100 may be further configured to adjust the locked position based upon the position of the user's hips with respect to the seat cushion 16 and/or seat back 18. A position sensor 42 is configured to detect the position of the hips of a user with respect to the bottom of the seat back 18, or the user side surface of the seat cushion 16. The position sensor 42 may be a load sensor 46 disposed within the seat cushion 16. Thus, by experiencing a load and the location of the load with respect to the seat cushion 16, a processor 44 may be programmed to calculate the space between the back side of the user and the front side of the seat cushion 16. The calculated space may be processed so as to adjust the position of the locked position, the “adjusted locked position.” Specifically, the calculated space may be used to set the locked position of the seat belt anchor 30 to a position adjacent the hips of the user. Accordingly, the position sensor 42 is configured to determine the location of the hips so as to allow the seat belt anchor 30 to adjust its locked position so as to place the seat belt 14 over the pelvis of the user.

The seat assembly 100 may further including a drive 38, a memory unit 48 and an input 50. The drive 38 may be a motorized unit configured to move the seat belt anchor 30 between the locked position and the receiving position as described above. The memory unit 48 may be an electronic medium configured to store data. The input 50 is configured to interface with the memory unit 48 so as to select predetermined data. For instance, the memory unit 48 may be configured to store multiple adjusted locked positions and/or receiving positions. The input 50 may be actuated so as to interface with the memory unit 48 and recall a selected receiving or adjusted locked positions stored in the memory unit 48. Accordingly, the memory unit 48 may be configured to store the position of the receiving position which the user has adjusted from a factory set position. The memory unit 48 may be further configured to store an adjusted locked position. The stored adjusted locked positions may be associated with a particular user. Thus, if two users have profiles stored in a vehicle 22 and both users slouch, the adjusted locked position for one user may be forward of the adjusted locked position of another user.

The processor 44 may be further configured to detect a first event and a second event. The first event is a signal which indicates to the drive 38 to move the seat belt anchor 30 from the receiving position to the locked position. The second event is a signal which indicates to the drive 38 to move the seat belt anchor 30 from the locked position to the receiving position. A first event may be established when the user sits on the seat cushion 16 and the seat belt 14 buckle 24 is coupled to the seat belt anchor 30. Thus, when the seat belt assembly 10 recognizes a first event, the drive 38 is actuated so as to move the seat belt anchor 30 from the receiving position to the locked position. The second event may be when the user disengages the belt buckle 24 from the seat belt anchor 30 and leaves the seat 12 after a driving event. Thus, for instance, having driven, the user may park the car and turn off the ignition and disengage the seat belt 14 from the seat belt anchor 30 wherein the seat belt anchor 30 moves from the locked position to the receiving position. Thus, being in the receiving position prior to a driving event ensures that the belt buckle 24 is received by the seat belt anchor 30 forward of the abdomen of the user thus sliding a portion of the belt along the lap of the user and positioning the belt above the pelvis so as to ensure the seat belt 14 is fitting properly.

Obviously, many modifications and variations of the present invention are possible in light of the above teachings and may be practiced otherwise than as specifically described while within the scope of the appended claims.

1. A seat belt assembly for use with a seat having a seat cushion and a seat back, the seat belt assembly having a belt buckle slidably mounted to a seat belt, the seat belt assembly configured to drag the seat belt across the lap of the user so as to position the seat belt over the pelvis of the user, the seat belt assembly comprising:
a seat belt anchor movable between a locked position and a receiving position, the locked position being generally adjacent a back edge of the seat cushion and proximate the seat back, the receiving position forward of the locked position wherein the seat belt anchor receives the belt in the receiving position and the seat belt anchor is moved back to the locked position so as to help ensure the belt is positioned under the abdomen of a user.

2. The seat belt assembly as set forth in claim 1, further including a drive configured to move the seat belt anchor between the locked position and the receiving position.

3. The seat belt assembly as set forth in claim 1, further including a rail, the seat belt anchor mechanically attached to the rail, and movable along the rail between the locked position and the receiving position.

4. The seat belt assembly as set forth in claim 3, wherein the rail is mounted to the seat cushion.

5. The seat belt assembly as set forth in claim 3, wherein the rail is mounted to a floor of a cabin space the seat is disposed.

6. The seat belt assembly as set forth in claim 1, further including a position sensor configured to detect the position of the hips of a user with respect to the bottom of the seat back, the position sensor in communication with a drive, the drive receiving a signal from the position sensor and setting the locked position of the seat belt anchor in a predetermined alignment with the hips of the user.

7. The seat belt assembly as set forth in claim 6, wherein the position sensor is a load sensor disposed within the seat cushion.

8. The seat belt assembly as set forth in claim 2, further including a memory unit and an input, the memory unit configured to store at least one location of the receiving position, the input configured to recall any one of the at least one location of the receiving position so as to actuate the drive and place the seat belt anchor in the selected at least one location of the receiving position.

9. The seat belt assembly as set forth in claim 2, further including a processor, the processor configured to detect a first event and a second event, wherein the first event signals to the drive to move the seat belt anchor from the receiving position to the locked position, and the second event signals to the drive to move the seat belt anchor from the locked position to the receiving position.

10. The seat belt assembly as set forth in claim 9, wherein the first event is when the user sits on the seat cushion and the seat belt buckle is coupled to the seat belt anchor.

11. The seat belt assembly as set forth in claim 9, wherein the second event is when the user disengages the seat belt from the seat belt anchor, and leaves the seat.

12. A seat assembly having a seat cushion, a seat back and a seat belt assembly, the seat belt assembly having a belt buckle slidable along a seat belt, the seat assembly configured to help position the belt over the pelvis of the user, the seat assembly comprising:
a seat belt anchor movable between a locked position and a receiving position, the locked position being generally adjacent a back edge of the seat cushion and proximate the seat back, the receiving position forward of the locked position wherein the seat belt anchor receives the belt in the receiving position and the seat belt anchor is moved back to the locked position so as to help ensure the belt is positioned over the pelvis of a user.

13. The seat assembly as set forth in claim 12, further including a rail, the seat belt anchor mechanically attached to the rail, and movable along the rail between the locked position and the receiving position.

14. The seat assembly as set forth in claim 12, further including a drive configured to move the seat belt anchor between the locked position and the receiving position.

15. The seat assembly as set forth in claim 12, further including a memory unit and an input, the memory unit configured to store at least one location of the receiving position, the input configured to recall any one of the at least one location of the receiving position so as to actuate the drive and place the seat belt anchor in the selected at least one location of the receiving position.

16. The seat assembly as set forth in claim 12, further including a processor, the processor configured to detect a first event and a second event, wherein the first event signals to the drive to move the seat belt anchor from the receiving position to the locked position, and the second event signals to the drive to move the seat belt anchor from the locked position to the receiving position.

17. The seat belt assembly as set forth in claim 12, wherein the first event is when the user sits on the seat cushion and the seat belt buckle is coupled to the seat belt anchor.

18. The seat belt assembly as set forth in claim 12, wherein the second event is when the user disengages the seat belt from the seat belt anchor, and leaves the seat.

19. A seat belt assembly for use with a seat having a seat cushion and a seat back, the seat belt assembly having a buckle slidably mounted to a belt, the seat belt assembly configured to drag the seat belt across the lap of the user so as to position the seat belt over the pelvis of the user, the seat belt assembly comprising:
a seat belt anchor and a rail, the seat belt anchor movable along the rail between a locked position and a receiving position, the locked position being generally adjacent a back edge of the seat cushion and proximate the seat back, the receiving position forward of the locked position wherein the seat belt anchor receives the belt in the receiving position and the seat belt anchor is moved back to the locked position so as to help ensure the belt is positioned under the abdomen of a user.

20. The seat belt assembly as set forth in claim 19, further including a drive configured to move the seat belt anchor between the locked position and the receiving position.

21. The seat belt assembly as set forth in claim 19, wherein the rail is mounted to the seat cushion.

22. The seat belt assembly as set forth in claim 19, wherein the rail is mounted to a floor of a cabin space the seat is disposed.
